(19) United States
(12) Patent Application Publication
(10) Pub. No.: US 2014/0097738 A1
(43) Pub. Date: Apr. 10, 2014

(54) LIGHTING DEVICE

(71) Applicant: Kabushiki Kaisha Toshiba, Minato-ku (JP)

(72) Inventors: Shusuke MORITA, Fukaya-shi (JP); Masahiro Yokota, Fukaya-shi (JP); Osamu Ono, Fukaya-shi (JP); Takeshi Ookawa, Kumagaya-shi (JP); Ken Takahashi, Kumagaya-shi (JP); Nobuo Kawamura, Kumagaya-shi (JP); Hideo Oota, Tokyo (JP); Hidemi Matsuda, Toda-shi (JP); Takashi Nishimura, Fukaya-shi (JP)

(73) Assignee: Kabushiki Kaisha Toshiba, Minato-ku (JP)

(21) Appl. No.: 14/102,984

(22) Filed: Dec. 11, 2013

Related U.S. Application Data
(63) Continuation of application No. PCT/JP2012/066660, filed on Jun. 29, 2012.

(30) Foreign Application Priority Data
Jun. 30, 2011 (JP) 2011-146581
May 30, 2012 (JP) 2012-123784

(51) Int. Cl. F21K 99/00

(52) U.S. Cl. CPC F21K 9/10; F21K 9/135; F21K 9/17
USPC 313/116

(57) ABSTRACT

According to one embodiment, a lighting device includes a light source with a directivity and a light-transmitting cover including a light-transmitting area configured to emit light from the light source to the outside. The light-transmitting cover is in a dome shape and formed of a material doped with scattered fillers dispersed in a volume thereof. The light-transmitting cover includes a vertically elongated shape with an aspect ratio higher than 0.6, and having a transmittance of 70% or less. The aspect ratio is the quotient of a height of the light-transmitting area in an optical axis thereof divided by the width of a rear-end portion of the light-transmitting area.

### CROSS REFERENCE TO RELATED APPLICATIONS

This application is a Continuation Application of PCT Application No. PCT/JP2012/066660, filed Jun. 29, 2012 and based upon and claiming the benefit of priority from prior Japanese Patent Applications No. 2011-146581, filed Jun. 30, 2011; and No. 2012-123784, filed May 30, 2012, the entire contents of all of which are incorporated herein by reference.

### FIELD

Embodiments described herein relate generally to a bulb-type or fluorescent-lamp-type lighting device using a highly directive light source, such as a light-emitting diode (LED).

### BACKGROUND

Electric bulbs and fluorescent lamps are widely used as lighting devices. Incandescent bulbs based on light emission by heat from filaments and fluorescent-lamp-type bulbs that accommodate convoluted fluorescent lamps have become widely used as bulb-type lighting devices, and straight or circular fluorescent lamps have been widely used as the fluorescent lamps. However, they have had problems of short life, infrared emission (ultraviolet emission), mercury use, luminous efficiency, etc.

In recent years, LED light sources and electroluminescent (EL) light sources have been developed as technologies to solve these problems, and use of the LED light sources, in particular, for bulb-type lighting devices have been exponentially spread.

A conventional LED light source of the surface mounting type has such directivity that the luminous intensity is attenuated in proportion to cos θ, where θ is the angle between the normal to a mounting substrate and light strongly emitted normally to the mounting substrate. This is because the conventional LED light source is configured so that an LED chip that emits a primary light beam is covered by a flat protective layer containing a phosphor that converts the primary light beam into a secondary light beam. Thus, an LED bulb using an LED light source has such a distribution of luminous intensity that light normal to the mounting substrate is strong and hardly any light is emitted laterally or rearwardly relative to the mounting substrate. If a conventional incandescent or fluorescent lamp bulb that has a substantially uniform distribution of luminous intensity from front to back is replaced with the LED bulb, therefore, the brightness of the ceiling and walls is inevitably greatly changed, resulting in a differently illuminated space.

A technique in which LED mounting surfaces are disposed laterally and rearwardly is proposed as a technique to also emit light rearwardly by means of an LED bulb. As another technique, moreover, a lighting device is proposed in which the inner surface of a light-transmitting cover is coated with a phosphor that can be excited by light from an LED light source, whereby the light-transmitting cover itself glows. Still another technique is proposed in which a light source is provided at the bottom portion of a spherical light-transmitting cover.

In the case where the LED light source is arranged to face laterally or rearwardly in the above-described manner, however, there are problems that the manufacture and assembly of the LED bulb are complicated and difficulties in designing the mechanical strength and radiation performance inevitably increase. In the case where the light-transmitting cover is coated with the phosphor, moreover, the manufacture and assembly of the LED bulb are also complicated. In the case where the light-transmitting cover is formed in a spherical shape, the light-transmitting cover should be made of two parts divided by an equatorial plane to facilitate mold removal in injection molding with high mass-producibility, so that there is a problem that mass-productivity is reduced.

### BRIEF DESCRIPTION OF THE DRAWINGS

FIG. 1 is a sectional view showing a bulb-type lighting device according to a first embodiment;

FIG. 2A is an enlarged sectional view showing portion A shown in FIG. 1;

FIG. 2B is a sectional view of a light-transmitting cover for illustrating a surface scattering function of a light-transmitting cover compared with a volume scattering function;

FIG. 3 is a sectional view showing a plurality of lighting devices comprising light-transmitting covers with different aspect ratios;

FIG. 4 is a diagram showing the relationships between the transmittance, aspect ratio, and 28 light distribution angle of a light-transmitting cover according to the first embodiment;

FIG. 5 is a diagram showing the relationships between the front transmittance and light distribution angle of the light-transmitting cover;

FIG. 6 is a sectional view showing a lighting device according to a first modification of the first embodiment;

FIG. 7 is a sectional view showing a lighting device according to a second modification of the first embodiment;

FIG. 8 is a diagram illustrating an effect of an irregularity formed on a light-transmitting cover;

FIG. 9 is a diagram showing characteristics corresponding to various shapes of the light-transmitting cover;

FIG. 10 is a sectional view showing a bulb-type lighting device according to a second embodiment;

FIG. 11A is a diagram showing light distribution characteristics of the lighting device of the second embodiment;

FIG. 11B is a diagram showing light distribution characteristics of the lighting device of the second embodiment;

FIG. 11C is a diagram showing light distribution characteristics of the lighting device of the second embodiment;

FIG. 12 is a diagram illustrating the definition of the light distribution characteristics according to the second embodiment;

FIG. 13 is a diagram showing influences of changes of the transmittance and aspect ratio of the light-transmitting cover on the maximum peak angle;

FIG. 14 is a view showing a fluorescent-lamp-type lighting device according to a third embodiment;

FIG. 15 is a lighting device according to a first modification of the third embodiment;

FIG. 16 is a lighting device according to a second modification of the third embodiment;

FIG. 17A is a side view showing a fluorescent-lamp-type lighting device according to a fourth embodiment;

FIG. 17B is a perspective view showing the fluorescent-lamp-type lighting device according to the fourth embodiment;

FIG. 17C is a sectional view showing the fluorescent-lamp-type lighting device according to the fourth embodiment;

FIG. 17D is a diagram showing light distribution characteristics of the lighting device according to the fourth embodiment;

FIG. 18A is a sectional view showing the aspect ratio of the cross-section of a light-transmitting cover;

FIG. 18B is a diagram showing influences of change of the aspect ratio of the cross-section of the light-transmitting cover on the 20 light distribution angle and efficiency;

FIG. 19 is a diagram showing obliquely viewed images of a light-transmitting portion with the aspect ratio of the cross-section of the light-transmitting cover changed;

FIG. 20 is a sectional view showing a lighting device according to a first modification of the fourth embodiment;

FIG. 21 is a sectional view showing a fluorescent-lamp-type lighting device according to a fifth embodiment;

FIG. 22A is a sectional view of a fluorescent-lamp-type lighting device according to a first modification of the fifth embodiment;

FIG. 22B is a sectional view of a fluorescent-lamp-type lighting device according to a second modification of the fifth embodiment; and

FIG. 23 is a sectional view showing a fluorescent-lamp-type lighting device according to a sixth embodiment.

### DETAILED DESCRIPTION

Various embodiments will be described in detail with reference to drawings. In general, according to one embodiment, a lighting device comprises a light source with a directivity, configured to emit a visible light beam, and a light-transmitting cover comprising a light-transmitting area covering at least a front of the light source and configured to emit light from the light source to the outside. The light-transmitting cover is in a dome shape with a noncircular cross-section, made of a material doped with scattered fillers dispersed in a volume thereof. The light-transmitting cover comprises a vertically elongated shape with an aspect ratio higher than 0.6, and has a transmittance of 70% or less. The aspect ratio is the quotient of a height of the light-transmitting area in an optical axis thereof divided by the width of a rear-end portion of the light-transmitting area.

### First Embodiment

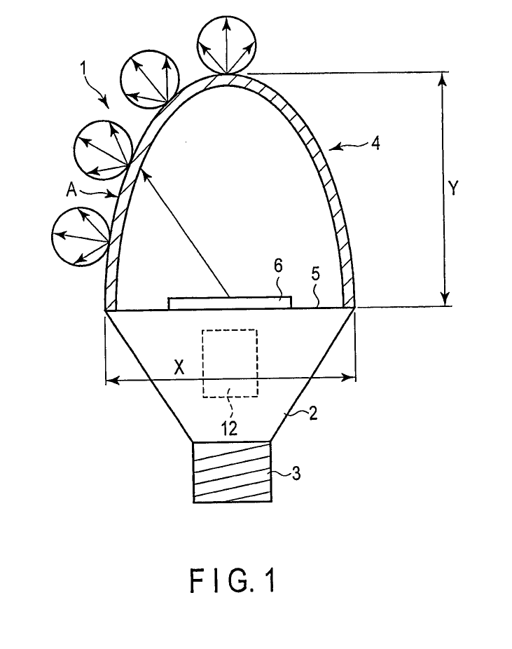

FIG. 1 shows an LED bulb 1 for use as a bulb-type lighting device according to a first embodiment. FIG. 1 is a sectional view, and the LED bulb 1 has a shape rotationally symmetrical with respect to a central axis.

The bulb 1 comprises a base member 2 having a flat mounting surface 5 on the front side, a light source 6 formed of an LED with directivity that emits a visible light beam, and light-transmitting cover 4 through which light emitted from the light source 6 is radiated to the outside. The base member 2 serves both as a metallic housing and as a heat radiating member and is substantially in the shape of a frustum of a cone, having the flat mounting surface 5 at the upper end, and an E17 or E26 cap 3 is attached to its lower end. A drive circuit 12 is accommodated in the base member 2. Electricity supplied through the cap 3 is introduced to the light source 6 to cause it to emit light by the drive circuit 12. The base member 2 holds the light-transmitting cover 4 and cap 3, thereby defining the external shape of the LED bulb 1, and doubles as a heat sink and a radiator plate for heat from the light source 6.

The light-transmitting cover 4 is made of, for example, a milk-white resin doped with scattered fillers dispersed in its volume and is in the form of a structure with a semi-elliptical or partially spherical cross-section about 1.5 mm thick. The transmittance of the light-transmitting cover 4 is set as low as 45%.

Further, the light-transmitting cover 4 is in the form of an open-bottomed noncircular dome, for example, a vertically elongated dome, the lower end of which is secured to the peripheral edge portion of the mounting surface 5 of the base member 2. The light-transmitting cover 4 comprises a light-transmitting area that covers at least the front of the light source 6 and serves to emit light from the light source 6 to the outside. In the present embodiment, the entire light-transmitting cover 4 constitutes the light-transmitting area and covers the front and side surfaces of the light source 6.

If the height of the light-transmitting area of the light-transmitting cover 4 and the width of a rear-end portion of the light-transmitting area are Y and X, respectively, the light-transmitting cover 4 has a forward-tapered inner surface with a maximum diameter X at the rear-end portion and can be shaped by die-cutting a single part in an injection molding process with high mass-producibility. The light-transmitting cover 4 has a semi-elliptical cross-sectional shape with the opening diameter X of 35 mm and height Y of 28 mm and in a vertically elongated shape with an aspect ratio (Y/X) of the height of the light-transmitting cover to the opening diameter of 0.8. The height Y of the light-transmitting cover 4 represents a height in the direction of an optical-axis substantially perpendicular to the emitting surface of the light source 6.

In the first embodiment, the light-transmitting cover 4 has its transmittance reduced to 45% and has a vertically elongated elliptical shape. If the transmittance of the light-transmitting cover 4 is reduced, then the light from the light source 6 incident on the light-transmitting cover 4 indicated by an arrow in FIG. 1 will be caused to stray. Thus, distribution characteristics of emitted light will be exhibited such that the luminous intensity varies with a cosine-distribution relative to the direction normal to the surface of the light-transmitting cover 4 regardless of the direction of incidence of the light from the light source 6.

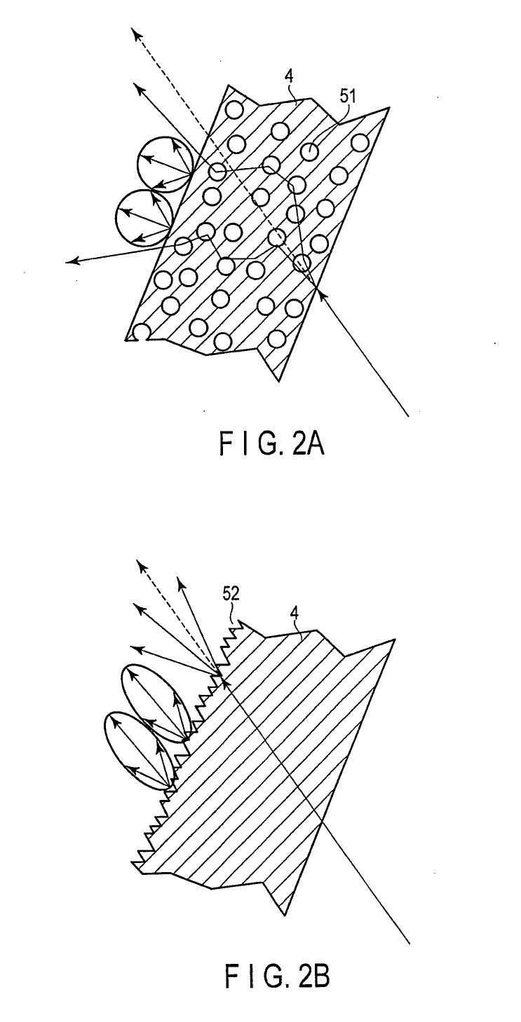

FIG. 2A is an enlarged sectional view showing a portion A of the light-transmitting cover 4 in FIG. 1. Scattering of light in the light-transmitting cover 4 will be described with reference to FIG. 2A.

As shown in FIG. 2A, the light-transmitting cover 4 is stuffed with scattering fillers 51 so that the scattering fillers 51 are dispersed throughout the volume of the light-transmitting cover 4. Light incident on the light-transmitting cover 4 is scattered by the scattering fillers 51 so that its course is altered as it passes through the light-transmitting cover 4. In the present embodiment, the scattering fillers 51 have a diameter greater than the wavelength of the light so that they are independent of the wavelength and are arranged with such a density that the mean free path of scattering is about 1/1,000 to 1/10 of the thickness of the light-transmitting cover 4. Specifically, the transmittance of the light-transmitting cover 4 is 70% or less, so that characteristics of distribution of luminous intensity with an intensive cosine-distribution in the direction normal to the surface of the light-transmitting cover 4 are exhibited in this area, regardless of the direction of incidence of the light from the light source 6 on the light-transmitting cover 4. This implies that the light-transmitting cover 4 behaves just like a light source without depending on the light source and the light distribution of the lighting device depends only on the shape of the light-transmitting cover 4. Thus, a high luminous intensity can be achieved with respect to the lateral direction, as shown in FIG. 1, by reducing the transmittance of the light-transmitting cover 4 and making the cross-sectional shape vertically elongated and semi-elliptical, so that the light distribution angle can be increased.

Such an effect cannot be easily achieved by surface texturing or frosting in which scattering is performed for only the surface of the light-transmitting cover, as shown in FIG. 2B, and can be achieved by dispersing the scattering fillers 51 throughout the volume of the light-transmitting cover, as shown in FIG. 2A, to increase the frequency of scattering.

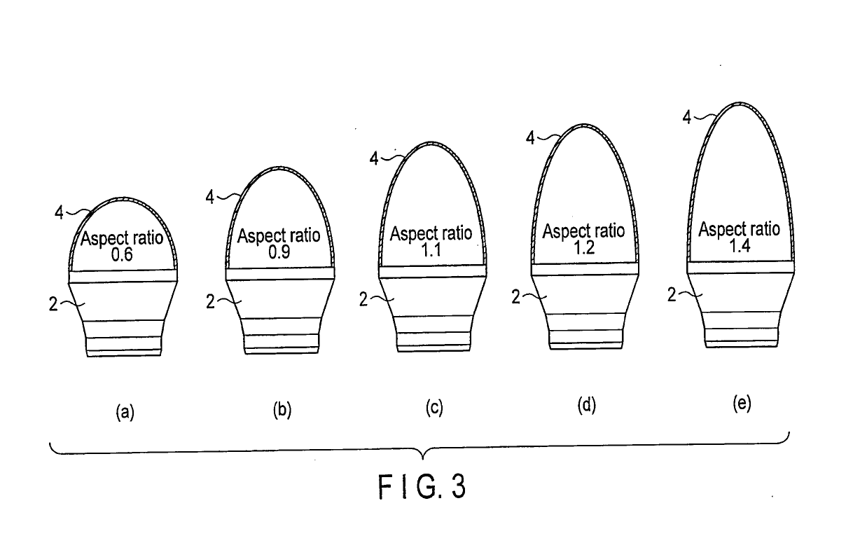

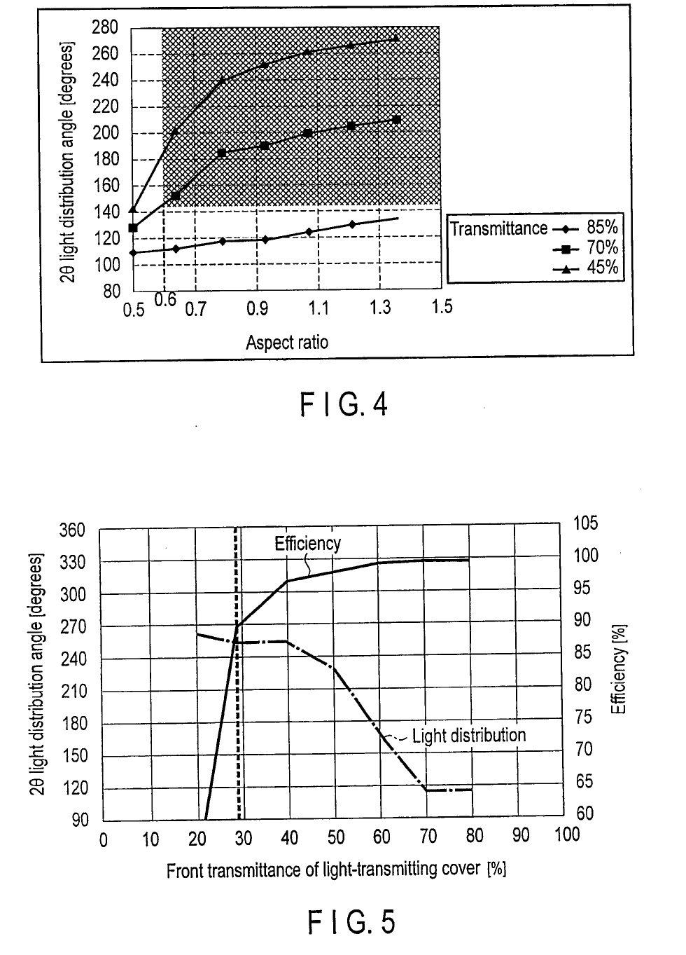

FIG. 3 shows various LED bulbs with light-transmitting covers 4 the aspect ratios of which vary within the range of 0.6 to 1.4. FIG. 4 shows characteristics obtained when the transmittances of the semi-elliptical light-transmitting covers of the various LED bulbs shown in FIG. 3 are changed, based on the abscissa and ordinate representative of the aspect ratio and 2θ light distribution angle, respectively. As seen from these drawings, the 2θ light distribution angle is remarkably increased by reducing the transmittance of the light-transmitting area of the light-transmitting cover 4 to 70% or less and forming the light-transmitting cover 4 into a vertically elongated shape with an aspect ratio higher than 0.5, or more specifically, into a vertically elongated shape with an aspect ratio of 0.6 or more in this case.

Hemispherical light-transmitting covers with transmittances of 85% or thereabouts have conventionally been used. If the transmittance is higher than 70%, however, the diffusion effect of the light-transmitting cover is so insufficient that a light beam easily passes through the cover, and a light distribution expansion effect cannot be obtained despite a vertically elongated shape.

Further, drastic efficiency degradation is caused if the transmittance of the light-transmitting cover 4 is too low. FIG. 5 shows the relationships between the transmittance, efficiency, and light distribution angle of a light-transmitting cover with an aspect ratio of 1.0. It can be seen that the efficiency is drastically degraded in the transmittance range of less than 30%. Furthermore, the light distribution angle is substantially saturated if the transmittance is40% or less. In the transmittance range of less than 40%, the stray inside the light-transmitting cover is sufficient, and only an excessive stray returns to the side of the light source and causes an absorption loss. Preferably, therefore, the transmittance of the light-transmitting cover 4 should be not lower than 30% and not higher than 70%. Furthermore, a wider light distribution angle can be obtained if the transmittance of the light-transmitting cover 4 is 60% or less.

According to the LED bulb 1 constructed in this manner, an angular range (light distribution angle) in which the luminous intensity is halved can be extended from 120°, a conventional value, to 240°. Further, if the opening of the light-transmitting cover 4 has the maximum diameter X, as in the present embodiment, there is an advantage that the light-transmitting cover manufactured by injection molding can be made of a single part. Since an effect can be produced by simple replacement with the existing light-transmitting cover 4, moreover, the light distribution of the lighting device can be widened without increasing production costs.

Although the configuration of the LED bulb is specified as required according to the first embodiment, the main feature of the present invention is to reduce the transmittance of the light-transmitting cover, which faces the highly directive light source, and make the aspect ratio of the light-transmitting cover higher, thereby deflecting light emitted from the light source 6 in the planar direction. The arrangement for light source mounting and the shapes of the light-transmitting cover and base member are not limited to the first embodiment and may be varied as required.

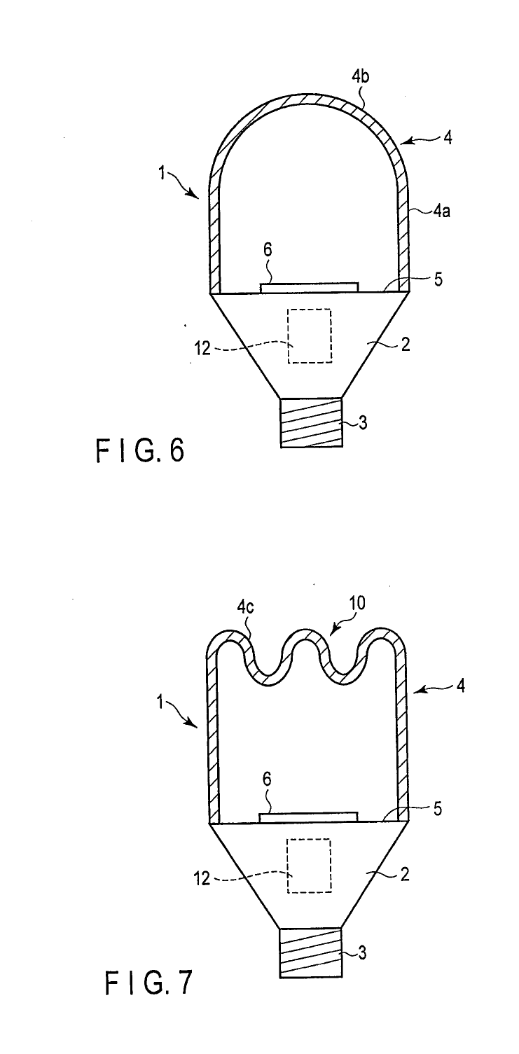

FIG. 6 shows an LED bulb 1 with a light-transmitting cover 4 according to a first modification of the first embodiment. According to the first modification, the light-transmitting cover is of a bullet-type that combines a cylindrical portion 4a, which is substantially equal in outer diameter to the base member 2, and a hemispherical portion 4b. The light-transmitting cover 4 has a vertically elongated shape with an aspect ratio higher than 0.6, and the transmittance of its area opposite the light source 6 is 70% or less and 30% or more.

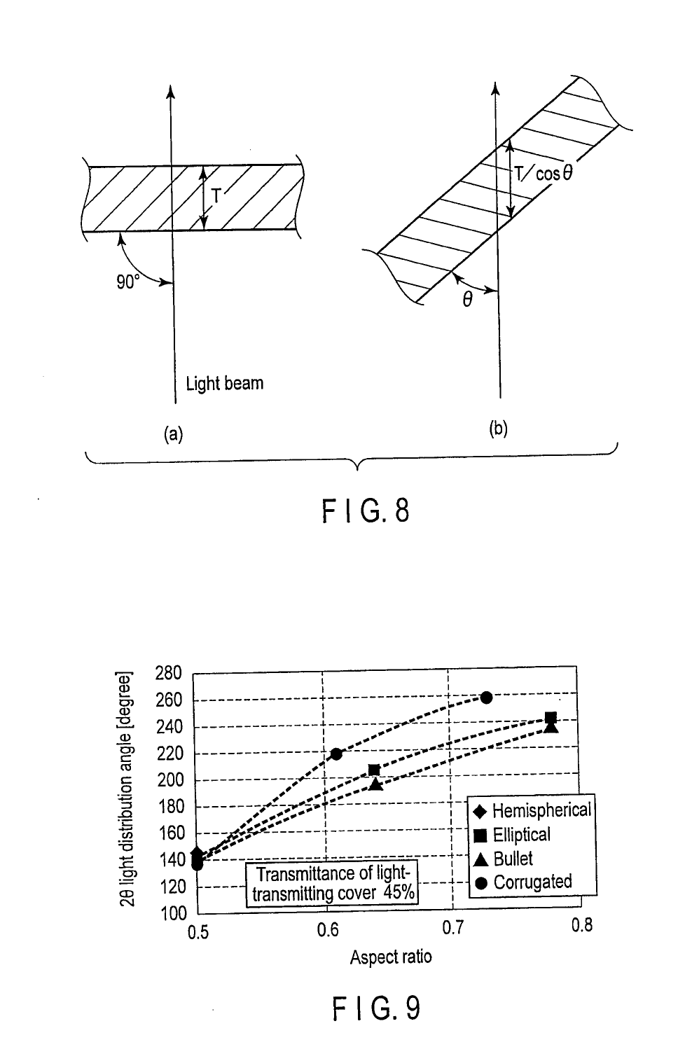

FIG. 7 shows an LED bulb 1 with a light-transmitting cover 4 according to a second modification. The light-transmitting cover 4 is in the form of a closed-top cylinder. The top surface of the light-transmitting cover 4, that is, a top portion 4c that faces the emitting surface of a light source 6, is formed with a continuous irregularity 10. This irregularity 10 is formed of, for example, a plurality of circular irregularities of different diameters coaxial with the central axis of the LED bulb 1, that is, a corrugated irregularity. The light-transmitting cover 4 has a vertically elongated shape with an aspect ratio higher than 0.6, and the transmittance of its area opposite the light source 6 is 70% or less and 30% or more. If the top portion 4c of the light-transmitting cover is flat, as shown in FIG. 8(a), light emitted from the light source 6 is incident substantially perpendicularly on the top portion 4c. If the top portion 4c of the light-transmitting cover 4 is in the form of the irregularity 10, as in the second modification, in contrast, light incident from the light source 6 is obliquely incident on the irregularity 10. Thus, a substantial thickness T of the light-transmitting cover 4 increased so that the incident light can be laterally diffused and scattered with high efficiency, as shown in FIG. 8(b). Since the light emitted from the light-transmitting cover 4 by the aforementioned scattering effect is strongly emitted in the direction normal to the light-transmitting cover 4, moreover, a laterally wider light distribution can be obtained if the light is inclined, as shown in FIG. 8(b). The irregularity 10 of the top portion 4c is not limited to the corrugated shape and may be selected from various irregularities, such as serrated irregularities, dot irregularities, etc.

FIG. 9 shows the relationships between the aspect ratio and light distribution angle for various shapes of the light-transmitting cover 4, for example, hemispherical, semi-elliptical, bullet, and corrugated shapes. In this case, the transmittance of the light-transmitting cover 4 is fixed to 45%. As seen from FIG. 9, the light distribution angle is generally increased by increasing the aspect ratio, although there are slight variations depending on the shape of the light-transmitting cover, and a vertically elongated shape with an aspect ratio of 0.6 or more is desirable for a wide light distribution.

The lighting device is not limited to the bulb-type, and a straight lighting device, such as a fluorescent lamp, can achieve the same function as that of the first embodiment if the transmittance of a light-transmitting cover is set to 70% or less and 30% or more and the cross-section has a vertically elongated shape with an aspect ratio higher than 0.6.

The following is a description of lighting devices according to alternative embodiments. In the description of the alternative embodiments to follow, like reference numbers are used to designate the same portions as those of the foregoing first embodiment, and a detailed description thereof is omitted.

### Second Embodiment

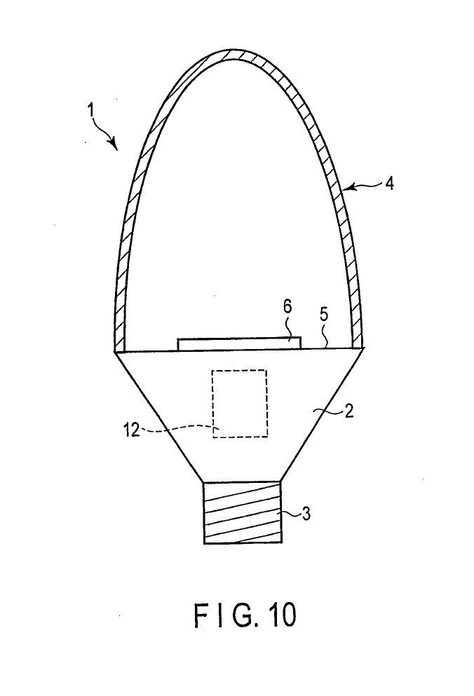

FIG. 10 shows an LED bulb 1 as a bulb-type lighting device according to a second embodiment.

Although its basic configuration is the same as that of the first embodiment, the second embodiment is configured so that a light-transmitting cover 4 has a transmittance of 45% and a vertically very elongated, semi-elliptical cross-sectional shape with an aspect ratio of 0.1.

The LED bulb 1 that can intensively laterally apply strong light can be achieved with this configuration. Bulbs of this type have become widely used in down-lights and the like based on fluorescent lamp bulbs and can be replaced with the LED bulb 1.

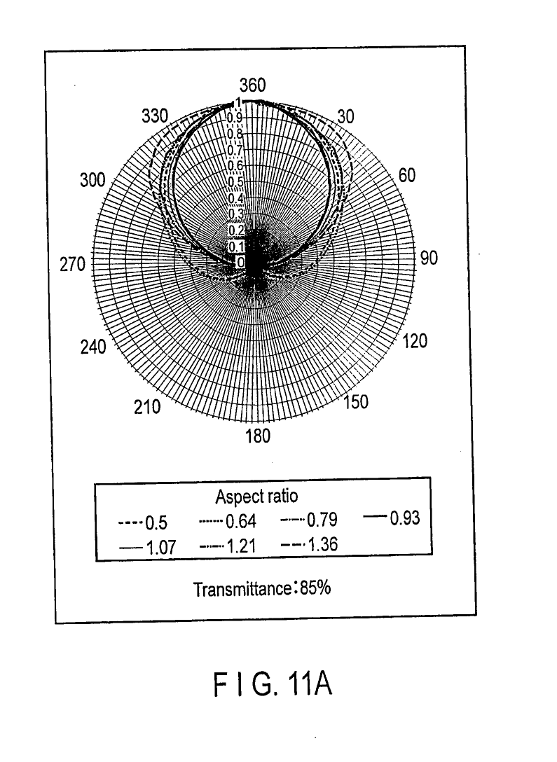

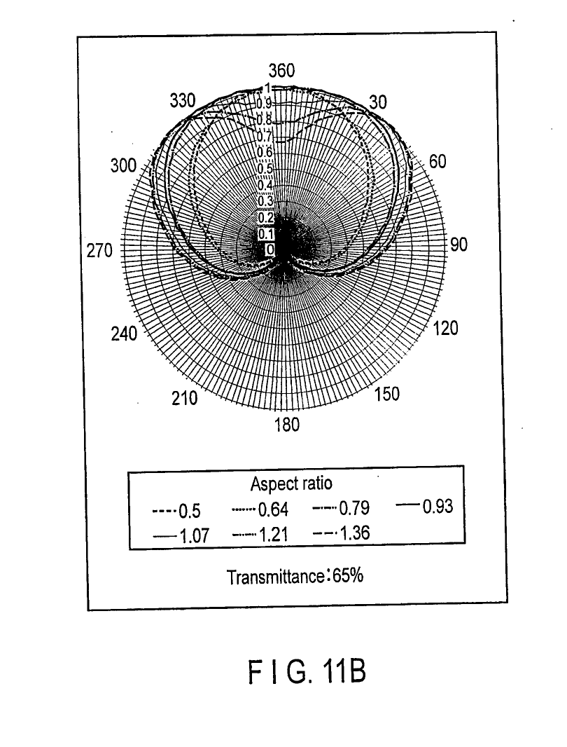

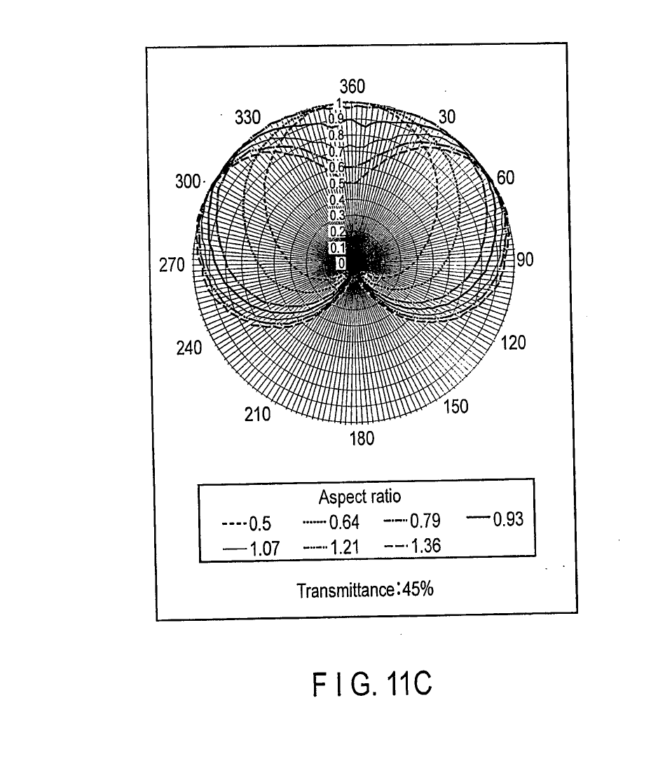

FIGS. 11A, 11B, and 11C show light distributions of the LED bulb 1 with the transmittance and aspect ratio of the light-transmitting cover 4 of the LED bulb 1 varied. If the transmittance is 85%, as shown in FIG. 11A, the light distribution indicates highly directive light peculiar to an LED just above the light source. If the transmittance is 65% or less, as seen from FIGS. 11B and 11C, however, the strong directivity just above the light source is reduced so that the maximum luminous intensity is shifted sideways as the aspect ratio increases. The lower and higher the transmittance and aspect ratio, respectively, the more conspicuous this tendency is.

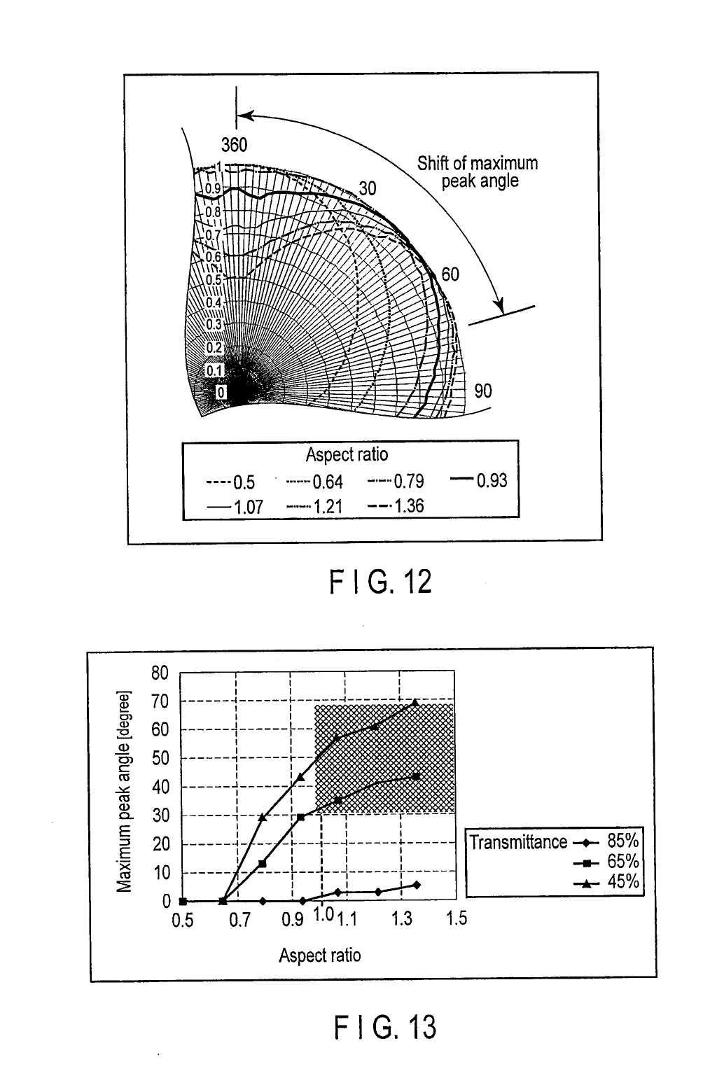

FIG. 12 is an enlarged version of a light distribution with the transmittance of the light-transmitting cover 4 at 45% shown in FIG. 11C. It can be seen that the maximum peak angle of the light distribution shifts from 0° toward 90° as the aspect ratio increases from 0.5%. FIG. 13 is a graph obtained by plotting the maximum peak angle and indicates a high-angle shift of the peak angle just above the light source to 70° at the maximum. If the light-transmitting cover is designed to have a transmittance of 65% or less and an aspect ratio of 1.0 or more, in particular, the luminous intensity in front of the LED bulb can be reduced to obtain an exclusive light distribution for the side surface.

Although the light-transmitting cover 5 is in the vertically elongated elliptical shape according to the embodiment, moreover, it may alternatively be cylindrical, like a T-bulb commercially available as a fluorescent lamp bulb. The T-bulb has a laterally intensive light distribution, as shown in FIG. 12, so that it can be replaced with an LED bulb without incompatibility both in properties and in appearance.

According to the first and second embodiments, as described above, there can be provided a lighting device with high mass-producibility, capable of extending the range of lateral irradiation.

### Third Embodiment

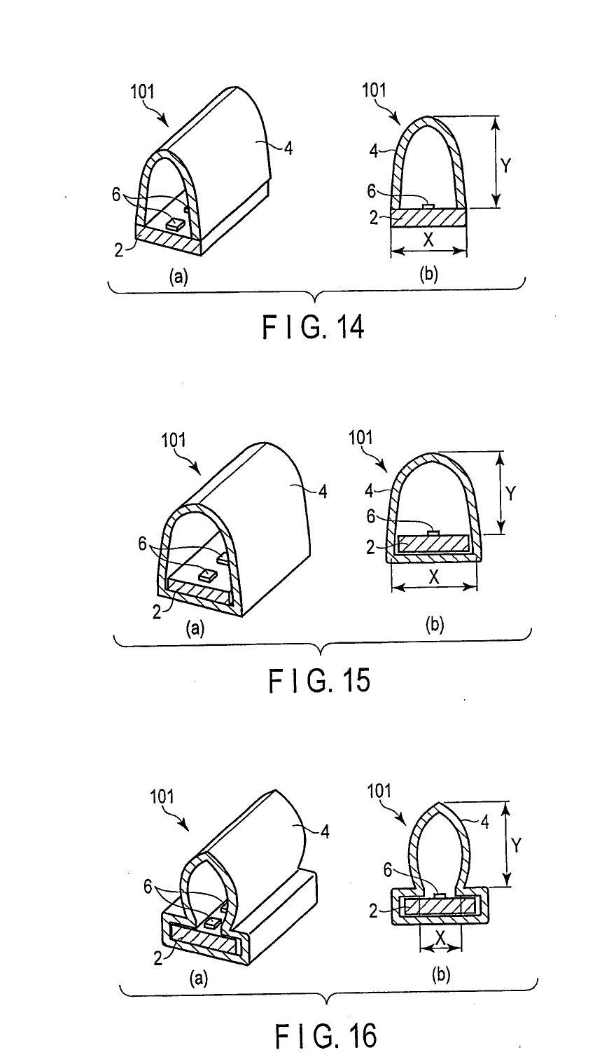

FIG. 14 shows an LED fluorescent lamp 101 as a fluorescent-lamp-type lighting device according to a third embodiment. The LED fluorescent lamp 101 has a straight shape and is shown partially in section in the drawing.

A base member 2 is a metallic plate extending straight, and a plurality of light sources 6 are linearly arranged on the top surface of the base member 2. The base member 2 has the functions of transferring and radiating heat produced by the light sources 6. A light-transmitting cover 4 is made of a milk-white resin doped with scattered fillers dispersed in its volume and is closely secured to the base member 2 so as to cover the light sources 6. The light-transmitting cover 4 defines a light-transmitting area for diffusing and emitting light from the light sources 6 to the outside.

The transmittance of the light-transmitting cover 4 is adjusted to 60% and its cross-section has a vertically elongated elliptical shape with a rear-end width X of 24 mm, height Y of 30 mm, and aspect ratio of 1.25. Based on this transmittance and cross-sectional shape, the light-transmitting cover 4 deflects and emits the light from the light sources 6 in the direction normal to the light-transmitting area, thereby extending the light distribution for the lighting device.

FIGS. 15 and 16 are perspective views, partially in section, showing LED fluorescent lamps according to a first modification and second modification, respectively, of the third embodiment.

In either of the first and second modifications, a light-transmitting cover 4 is tubular and a base member 2 is provided inside the light-transmitting cover. Thus, a junction between the base member 2 and light-transmitting cover 4 is eliminated to improve sealability.

In the first modification shown in FIG. 15, the light-transmitting area of the light-transmitting cover 4 has a vertically elongated elliptical cross-section with an aspect ratio of 1 based on X of 30 mm and Y of 30 mm. Thus, the light distribution of the LED fluorescent lamp 101 is extended.

In the first modification shown in FIG. 16, the light-transmitting area of the light-transmitting cover 4 has a vertically elongated elliptical cross-section bulging on either side and having an aspect ratio of 2 based on X of 15 mm and Y of 30 mm. Thus, the LED fluorescent lamp 101 has a light distribution with a high luminous intensity on the lateral side.

### Fourth Embodiment

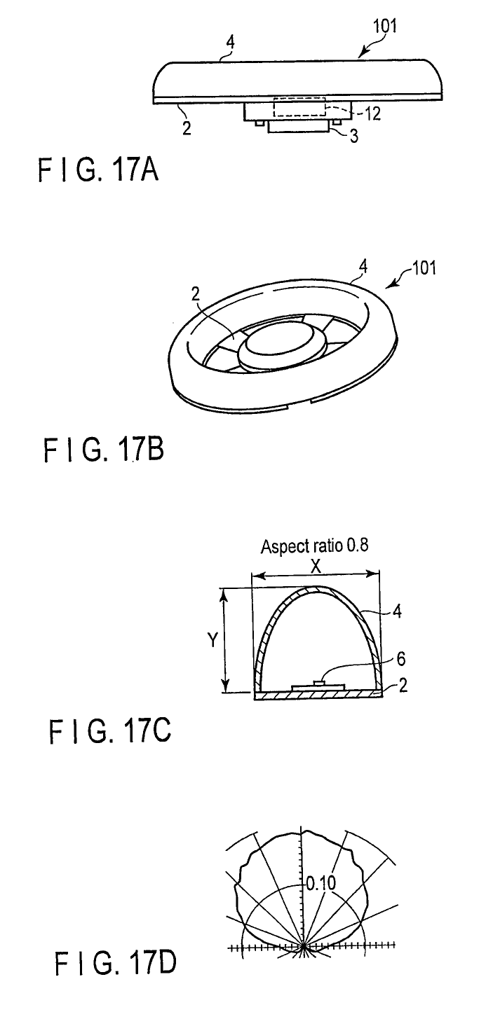

FIGS. 17A, 17B, 17C, and 17D show an LED fluorescent lamp 101 as a fluorescent-lamp-type lighting device according to a fourth embodiment.

FIG. 17A is a side view, FIG. 17B is a perspective view, FIG. 17C is an enlarged sectional view of a light-emitting portion, and FIG. 17D is a diagram showing a light distribution.

As shown in FIGS. 17A to 17C, the LED fluorescent lamp 101 is a lighting device based on an LED light source resembling an existing circular fluorescent lamp, and comprises a circular base member 2, a plurality of LED light sources 6 mounted on a front flat portion of the base member 2 and arranged side by side in a circle, and a doughnut-shaped light-transmitting cover 4 having a vertically elongated dome-like cross-section and covering the light sources 6.

The base member 2, which is metallic, combines the functions of transferring and radiating heat produced by the light sources 6 to the atmosphere side and serves as a housing extending to the central portion. A GX53 cap 3 is provided on the reverse side of the base member 2, and a drive circuit 12 is accommodated in a space between the cap 3 and base member 2.

The light-transmitting cover 4 is in the shape of a doughnut with an outer diameter of 200 mm, and its cross-section has a vertically elongated elliptical shape with an end width (X) of 30 mm on the side of the base member 2, height (Y) of 24 mm, and aspect ratio of 0.8. The light-transmitting cover 4 has scattered fillers dispersed in its volume and has a transmittance of 51%. By the effect described in connection with the first embodiment, the light distribution is expanded to a 20 light distribution angle of 150° without allowing the light sources 6 to be seen from the outside.

Thus, the light-transmitting cover 4 is formed by halving a vertically elongated ellipse, so that it can be mass-produced as a single part capable of being injection-molded and achieve improvement in optical properties and a good appearance, which will be indicated later.

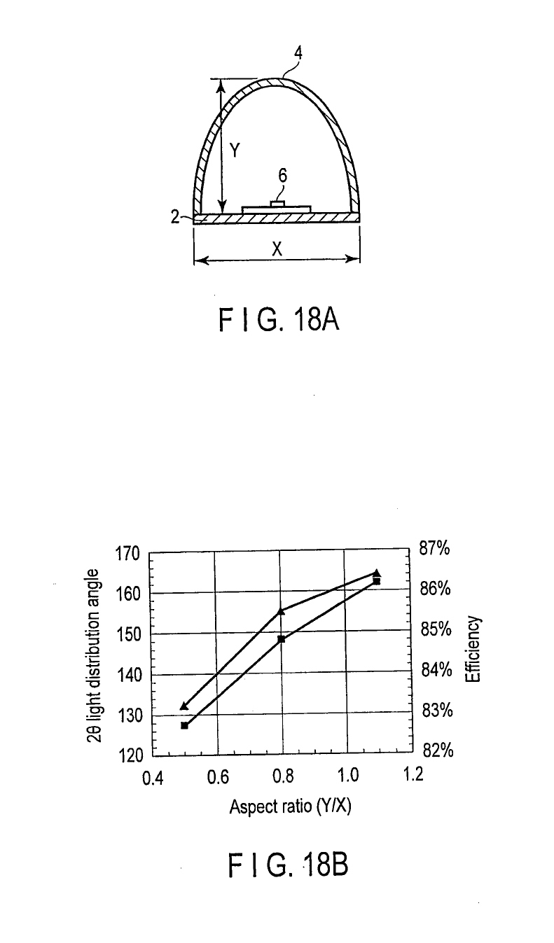

FIGS. 18A and 18B show the relationships between the aspect ratio, 2θ light distribution angle, and efficiency of the above-described LED fluorescent lamp 101. If the height Y is changed with the transmittance (51%) and width X (30 mm) of the light-transmitting cover 4 fixed, the higher the aspect ratio, the wider the 2θ light distribution angle is, and the higher the efficiency is. Thus, the higher the aspect ratio, the better the optical properties are.

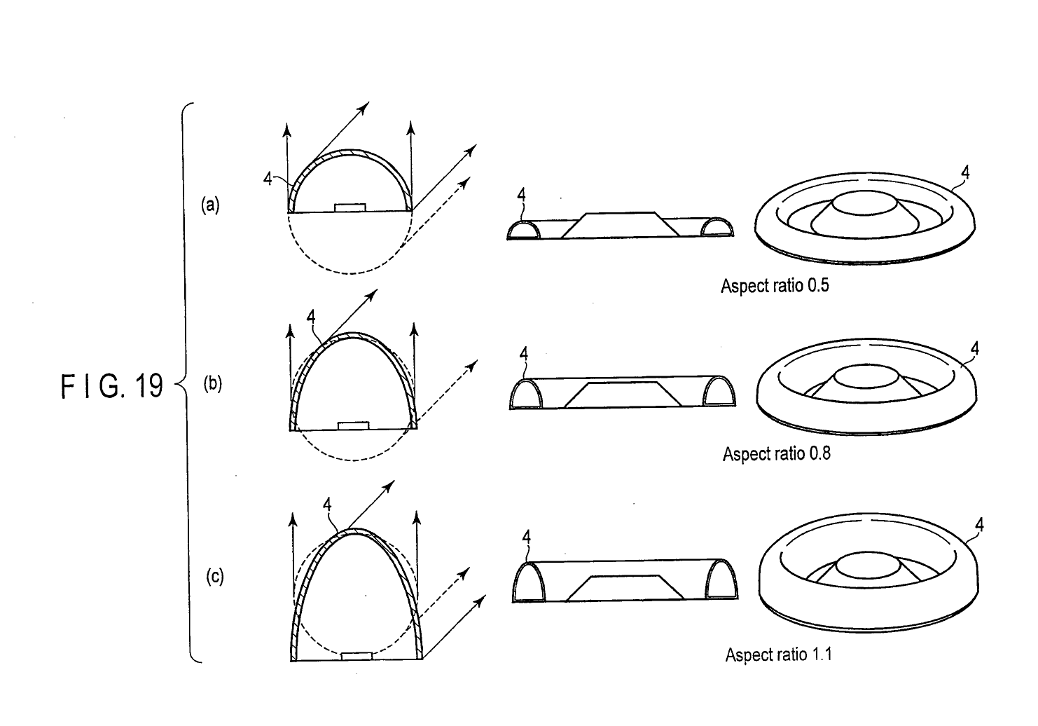

FIG. 19 shows sectional and perspective views illustrating light-emitting areas of the light-transmitting cover 4 with aspect ratios of 0.5, 0.8 and 1.1. If the cross-section of the light-transmitting cover 4 is perfectly circular, as shown in FIG. 19(a), the aspect ratio is 0.5. In this case, however, the light-transmitting cover 4 looks crushed when viewed obliquely. If the cross-section of the light-transmitting cover is in the shape of a vertically elongated dome, as shown in FIG. 19(c), in contrast, the cover inevitably looks unnaturally vertically elongated if its height exceeds the diameter of a perfect circle (aspect ratio of 1.0 or more). To give a natural impression, the aspect ratio of the light-transmitting area of the light-transmitting cover 4 should preferably range from 0.6 to 1.0, as shown in FIG. 19(b).

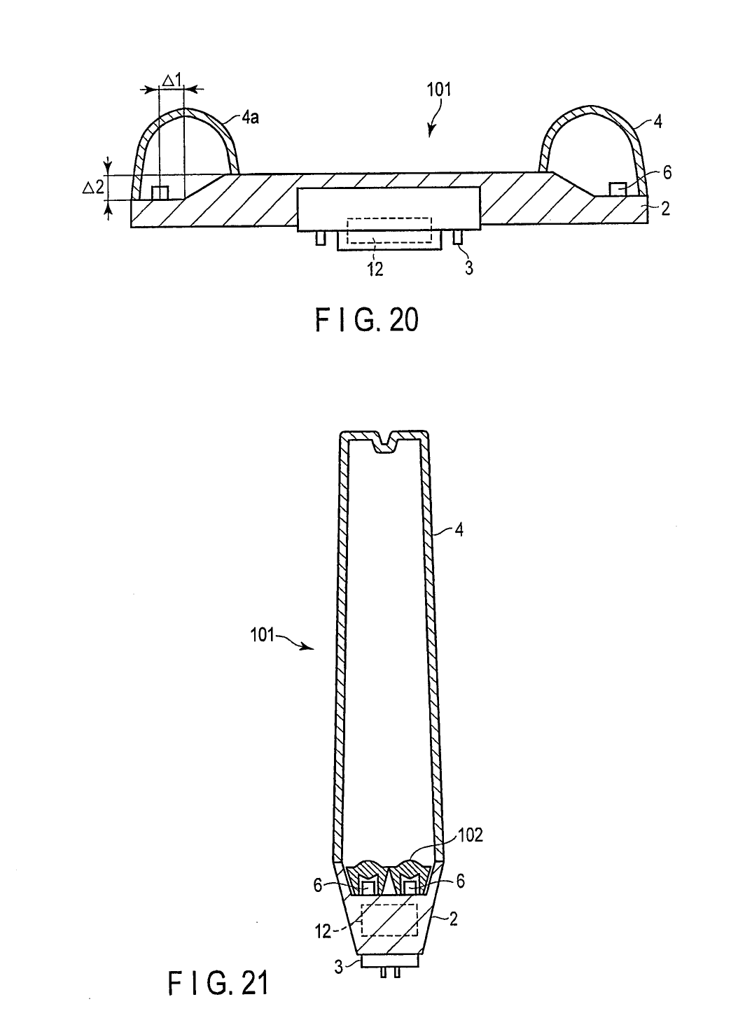

FIG. 20 is a sectional view showing an LED fluorescent lamp according to a first modification of the fourth embodiment. In this first modification, the inner peripheral height of an annular light-transmitting cover 4 is made lower than the outer peripheral height by Δ2, and a base member 2 is raised correspondingly. Further, the inner peripheral portion of the light-transmitting cover 4 is made thicker than the outer peripheral portion. LED light sources 6 are located eccentrically to the crosswise center of the light-transmitting cover 4 by Δ1 on the outer peripheral side so that the optical axes of the light sources 6 correspond to a slope area of the light-transmitting cover 4.

Structurally, the inner peripheral side of the light-transmitting cover 4 has a small influence on the spread of light distribution. Due to the property of the aspect ratio calculated on the outer peripheral side, therefore, the light distribution will not be degraded much even if the inner peripheral side portion is made lower than the outer peripheral side. Thus, according to the first modification, accommodation of a drive circuit and the like is facilitated while reducing the overall thickness of the LED fluorescent lamp 101, by reducing the height of the inner peripheral side of the light-transmitting cover 4 so that the base member 2 is raised.

Further, the light can be spread wider toward the outer periphery by making the outer peripheral side of the light-transmitting cover 4 thicker to reduce the transmittance. Based on the effect of oblique incidence described with reference to FIG. 8, moreover, the scattering function of the light-transmitting cover 4 can be improved by eccentrically arranging the light sources 6.

While the limited modification of the fourth embodiment is presented in FIG. 20, various other modifications may also be used. For example, the light sources 6 are not limited to a single-row arrangement and may alternatively be arranged in a plurality of rows in different radial positions. Further, the cross-sectional shape of the light-transmitting cover 4 is not limited to the vertically elongated elliptical shape and may alternatively be rectangular or triangular.

### Fifth Embodiment

FIG. 21 shows an LED fluorescent lamp 101 as a fluorescent-lamp-type lighting device according to a fifth embodiment.

The LED fluorescent lamp 101 comprises a base member 2, LED light sources 6, collimator lens 102, light-transmitting cover 4, and cap 3. The base member 2 accommodates a drive circuit 12. The light sources 6 are mounted on a front flat portion of the base member 2. The collimator lens 102 converges light emitted from the light sources 6. The light-transmitting cover 4 forwardly extends long from the base member 2 and resembles a fluorescent lamp. The cap 3, which matches an existing fluorescent lamp cap, such as Type GX10q, is provided on the back of the base member 2.

The light-transmitting cover 4 is in the form of a closed-top tube. The light-transmitting cover 4 has a substantially circular cross-section, opening diameter of 40 mm, and length of 200 mm, is somewhat tapered toward the distal end at an angle of 2° for mold removal, and has a transmittance of 60%. In such an extremely vertically elongated light-transmitting cover 4, only the vicinity of the light sources 6 becomes bright without the use of the collimator lens 102. However, uniform brightness can be distributed to the distal end of the light-transmitting cover 4 by condensing light by means of the collimator lens 102. In general, a collimator is required when 3 is exceeded by the aspect ratio of the light-transmitting area of the light-transmitting cover 4.

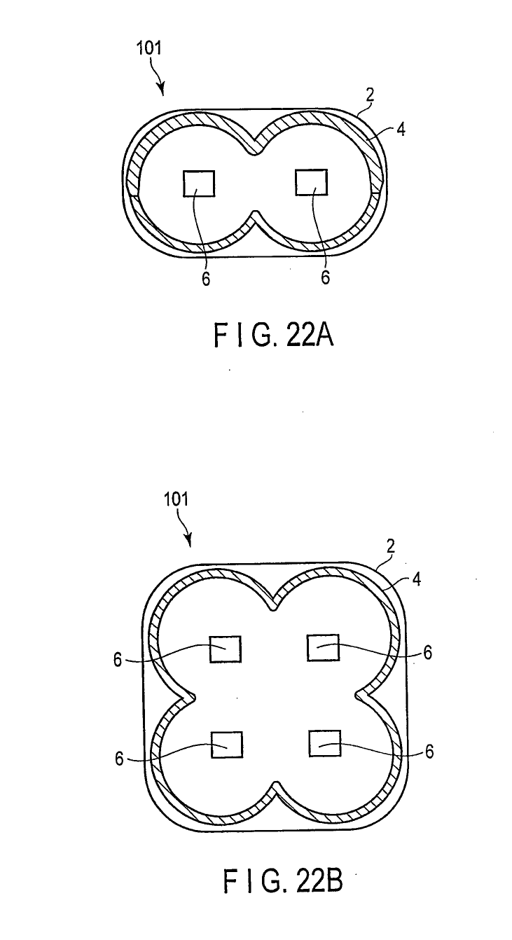

FIGS. 22A and 22B show the cross-sections of LED fluorescent lamps according to first and second modifications of the fifth embodiment, respectively.

In the first modification, as shown in FIG. 22A, a light-transmitting cover 4 that resembles an image of two commercially available fluorescent lamps is provided on a base member 2, and two LED light sources 6 are disposed on the base member 2 so that they are located on the respective tube centers of the fluorescent lamps. Since the direction of irradiation is restricted in consideration of use in a stand light, moreover, a more efficient design may be achieved by thickening one side of the light-transmitting cover 4 as illustrated.

In the second modification, as shown in FIG. 22B, a light-transmitting cover 4 that resembles an image of four fluorescent lamps is provided on a base member 2, and four LED light sources 6 are disposed on the base member 2 so that they are located on the respective tube centers of the fluorescent lamps.

Alternatively, the light sources 6 may be intensively disposed on the center of the light-transmitting cover 4 or arranged side by side in a circle. Further, the cross-section of the light-transmitting cover 4 may be circular or rectangular.

Although the length of the light-transmitting cover 4 to serve as a light-emitting portion is adjusted to 200 mm in the fifth embodiment, it may be freely set in accordance with the lengths of commercially available fluorescent lamps that vary from 100 to 1,200 mm.

### Sixth Embodiment

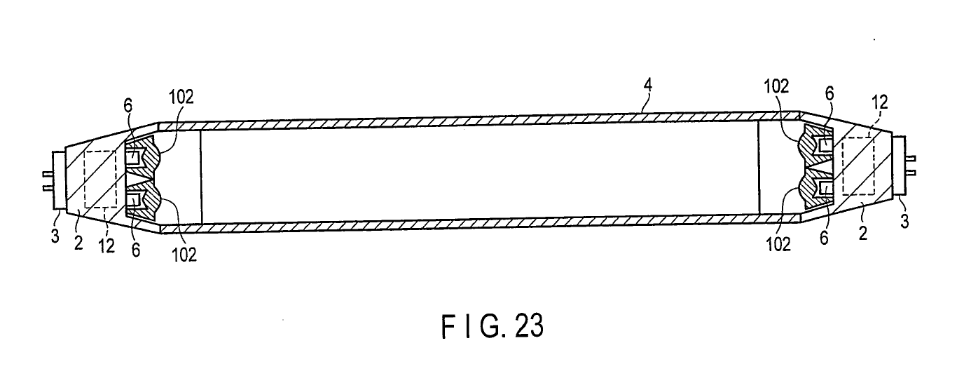

FIG. 23 shows an LED fluorescent lamp 101 as a fluorescent-lamp-type lighting device according to a sixth embodiment.

In the present embodiment, lighting devices of the type shown in the fifth embodiment described above are arranged face to face and constitute a straight-tube fluorescent-lamp-type lighting device. Specifically, base members 2, light sources 6, collimator lenses 102, and caps 3 are disposed at the opposite ends of a tubular light-transmitting cover 4, and each open end of the light-transmitting cover is supported by its corresponding base member 2.

With the LED fluorescent lamp 101 constructed as described above, the same effects and advantages as in the fifth embodiment can be obtained.

The present invention is not limited directly to the embodiments described above, and at the stage of carrying out the invention, its constituent elements may be embodied in modified forms without departing from the spirit of the invention. Further, various inventions can be formed by appropriately combining the constituent elements disclosed in the above-described embodiments. For example, some constituent elements may be deleted from all the constituent elements shown in the embodiments. Furthermore, constituent elements of different embodiments may be combined as required.

Although the above embodiments have been described as LED bulbs or LED fluorescent lamps, the lighting devices according to this invention may also be applied to street lighting and the like provided that they are based on combinations of directional light sources and light-transmitting covers surrounding the light sources. Further, the light sources are not limited to LEDs, and EL light sources may alternatively be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting device comprising:
a light source with a directivity, configured to emit a visible light beam; and
a light-transmitting cover comprising a light-transmitting area covering at least a front of the light source and configured to emit light from the light source to the outside,
the light-transmitting cover being in a dome shape with a noncircular cross-section, made of a material doped with scattered fillers dispersed in a volume thereof, the light-transmitting cover comprising a vertically elongated shape with an aspect ratio higher than 0.6, and having a transmittance of 70% or less, the aspect ratio being the quotient of a height of the light-transmitting area in an optical axis thereof divided by the width of a rear-end portion of the light-transmitting area.

2. The lighting device of claim 1, wherein the transmittance of the light-transmitting area is 65% or less.

3. The lighting device of claim 2, wherein the transmittance of the light-transmitting area is 30% or more.

4. The lighting device of claim 1, wherein a cross-section of the light-transmitting area comprises a tubular portion extending along the optical axis from the base member and a top portion which closes an upper end of the tubular portion, and the top portion is formed with a continuous irregularity.

5. The lighting device of claim 1, which comprises a direction indicative of a maximum luminous intensity of a light distribution, which is closer to a lateral side than to the front of the light source.

6. The lighting device of claim 5, wherein the aspect ratio of the light-transmitting cover is 1 or more.

7. The lighting device of claim 1, which is configured to be a bulb-type lighting device comprising an LED light source and resembling an incandescent bulb.

8. The lighting device of claim 1, which is configured to be a fluorescent-lamp-type lighting device comprising an LED light source and resembling a fluorescent lamp.

9. The lighting device of claim 1, which is configured to be a fluorescent-lamp-type lighting device comprising an LED light source and resembling a fluorescent lamp, and wherein the light-transmitting cover is in a shape obtained by halving a vertically elongated ellipse and comprises the aspect ratio of 0.6 to 1.0.

10. The lighting device of claim 9, which is configured to resemble a circular fluorescent lamp wherein the height of the light-transmitting area of the light-transmitting cover on the inside is different from that on the outside.

11. The lighting device of claim 9, which is configured to resemble a circular fluorescent lamp wherein a thickness of the light-transmitting area of the light-transmitting cover on the inside is different from that on the outside.

12. The lighting device of claim 9, which is configured to resemble a circular fluorescent lamp wherein the light source and the light-transmitting cover are located so that an axis of the light source obliquely crosses the light-transmitting area.

13. The lighting device of claim 1, which is configured to resemble a fluorescent lamp in a shape of a straight tube or a line bent in a U-shape, and comprises a light-transmitting area of the light-transmitting cover with the aspect ratio of 3 or more, a light source having an optical axis in a longitudinal direction of the light-transmitting area, and a collimator configured to converge the light from the light source in the longitudinal direction of the light-transmitting area.

14. The lighting device of claim 13, which is configured to resemble a fluorescent lamp in a shape of a straight tube comprising a light source on either axial end of the tube.
